(19) United States
(12) Patent Application Publication
(10) Pub. No.: US 2015/0205832 A1
(43) Pub. Date: Jul. 23, 2015

(54) ORGANIZATION OF METADATA FOR DATA OBJECTS

(71) Applicants: Robert Rundle, Albuquerque, NM (US); Nicolaas Pleun Bax, Hendrik Ido Ambacht (NL)

(72) Inventors: Robert Rundle, Albuquerque, NM (US); Nicolaas Pleun Bax, Hendrik Ido Ambacht (NL)

(73) Assignee: BAKER HUGHES INCORPORATED, Houston, TX (US)

(21) Appl. No.: 14/595,794

(22) Filed: Jan. 13, 2015

Related U.S. Application Data
(60) Provisional application No. 61/927,133, filed on Jan. 14, 2014.

(51) Int. Cl. G06F 17/30

(52) U.S. Cl. CPC G06F 17/30386; G06F 17/30309

(57) ABSTRACT

An embodiment of a non-transitory computer-readable storage medium stores instructions which, when processed by a processor, cause the processor to implement a method of storing and transmitting energy industry data. The method includes: storing a data set as an object, the data set including energy industry data; and generating metadata associated with the object, the metadata including at least an entity table storing a globally unique object identifier, a version table related to the entity table and storing a version identifier, a property table storing a property identifier that identifies a property described by the data set, and a value table related to the property table and storing a value of the property.

### CROSS-REFERENCE RELATED TO APPLICATION

This application claims the benefit of an earlier filing date from U.S. Provisional Application Ser. No. 61/927,133 filed Jan. 14, 2014, the entire disclosure of which is incorporated herein by reference.

### BACKGROUND

Various processing tools are utilized in relation to energy industry operations and are used to perform tasks including data collection, storage, modelling and analysis. Data from various sources (e.g., measurement and analysis data from various well locations and regions) can be aggregated in a repository for access by numerous users. Object-oriented programming is used to manage data sets, and involves the interaction among a plurality of data objects to implement a computer application.

Some data collection systems are configured as a distributed object system, which includes multiple nodes, each of which is capable of storing a variable amount of object data. Distributed objects may be spread over multiple computers in the system or multiple processors within a computer, and different objects may be managed by different users on different systems. Such distributed object systems might include a large number of nodes which are remotely located relative to one another and connected together in opportunistic ways.

### SUMMARY

An embodiment of a non-transitory computer-readable storage medium stores instructions which, when processed by a processor, cause the processor to implement a method of storing and transmitting energy industry data. The method includes: storing a data set as an object, the data set including energy industry data; and generating metadata associated with the object, the metadata including at least an entity table storing a globally unique object identifier, a version table related to the entity table and storing a version identifier, a property table storing a property identifier that identifies a property described by the data set, and a value table related to the property table and storing a value of the property.

An embodiment of a method of storing and transmitting energy industry data includes: storing a data set as an object, the data set including energy industry data; and generating metadata associated with the object, the metadata including at least an entity table storing a globally unique object identifier, a version table related to the entity table and storing a version identifier, a property table storing a property identifier that identifies a property described by the data set, and a value table related to the property table and storing a value of the property.

### BRIEF DESCRIPTION OF THE DRAWINGS

Referring now to the drawings wherein like elements are numbered alike in the several Figures:

FIG. 1 is a block diagram of an embodiment of a distributed data storage, processing and communication system;

FIG. 2 illustrates identifiers and metadata associated with a data object stored in the system of FIG. 1;

FIG. 3 is a diagram illustrating an embodiment of a data model for storing and organizing identifiers and metadata associated with a data object;

FIG. 4 illustrates exemplary relationships between versions of a data object; and

FIG. 5 illustrates an exemplary distributed computing system including a data repository.

### DETAILED DESCRIPTION

Apparatuses, systems, methods and computer program products are provided for collection, storage and transmission of data. An exemplary apparatus includes a computer program product for execution of a software program that manages data as objects stored in a distributed network. Each object stored in the network includes metadata and actual data. The program can be configured to manage any data distributed over a network to which multiple writers have access. For example, the data may be oil and gas or energy industry data, but is not limited thereto.

Energy industry data includes any data or information collected during performance of an energy industry operation, such as surface or subsurface measurement and modeling, reservoir characterization and modeling, formation evaluation (e.g., pore pressure, lithology, fracture identification, etc.), stimulation (e.g., hydraulic fracturing, acid stimulation), drilling, completion and production.

In one embodiment, the metadata for an object is organized and stored according to an entity-attribute-value (EAV) scheme. A data model for the metadata includes related tables or other data structure for object identification, parameter or attribute identification, and for parameter values.

While embodiments are detailed below with specific reference to distributed objects for explanatory purposes, alternate embodiments apply, as well, to other multi-version environments.

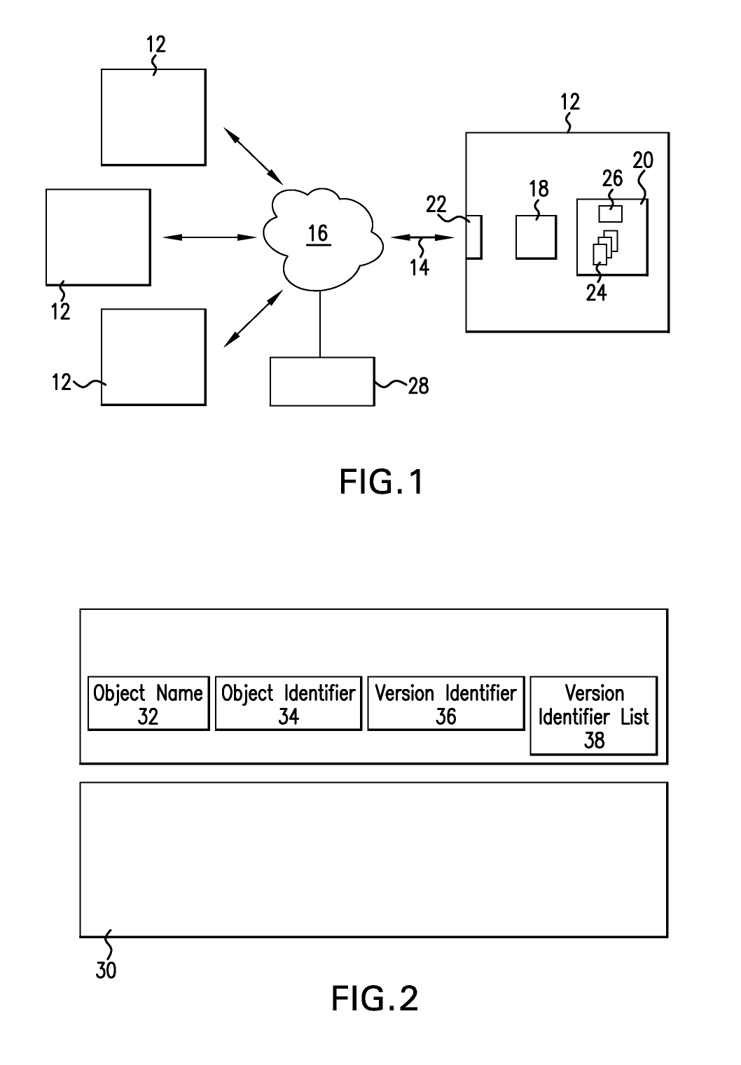

FIG. 1 is a block diagram of a distributed data storage, processing and communication system 10. The system 10 includes a plurality of processing devices or nodes 12. The nodes 12 each have computing components and capabilities, are connected by links 14, which may be wired or wireless. One or more of the nodes 12 may be connected via a network 16, such as the internet or an internal network. Each node 12 is capable of independent processing, and includes suitable components such as a processor 18, memory 20 and input/output interface(s) 22. The memory 20 stores data objects 24 or other data structures, and a program or program suite 26. The nodes may be computing devices of varying size and capabilities such as server machines, desktop computers, laptops, tablets and other mobile devices.

An exemplary program is an energy industry data storage, analysis and/or modeling software program. An example is JewelSuite™ analysis and modeling software by Baker Hughes Incorporated.

In one embodiment, the system includes one or more data storage locations. For example, the system 10 includes a centralized data repository 28. The repository 28 is accessible by each node 12. In one embodiment, the system 10 includes a Distributed Object Network, where each node 12 can access and be used to edit a distributed object, e.g., an object 24. Thus, users can independently retrieve copy and edit stored data. This independent editing may result in numerous different versions or copies of an object. As described herein, a “user” refers to a human or processing device capable of accessing and interacting with objects and/or data.

An object is a container for state information and also defines methods and properties that act on that state. An object type is a template that can be used to create an unlimited number of objects, which are initially identical, but become different as the object state changes.

In a distributed object system, some objects are transitory, derivative of other objects, or are otherwise of secondary importance to this discussion. Exemplary objects of interest are objects that map to real world objects, both physical and abstract, and together model the domain of interest. These objects are designated as domain objects. Exemplary domain objects in the oil and gas domain include fields, reservoirs, wells, geological grids, faults, horizons, and fluid contacts.

Examples of domain objects are wells and simulation grids. An example of an object that is not a domain object because of abstraction is a 3D view object that controls the view of an object, such as a subterranean reservoir data object. The state of the 3D view is serialized to an object file so that when the object file is reopened, the view of the reservoir is restored to the same viewing angle and zoom level. However the state of the 3D view object is irrelevant to the real world problem that is being analyzed, and thus this object is not considered a domain object. An example of an object that is not a domain object because of derivation is a well graphics object. The well graphics object implements rendering of a well domain object on the 3D view. The well graphics object contains no state of its own but accesses the state of the well domain object.

In a distributed object system, metadata provides a concise description of the object that can be distributed broadly while the actual data represents the complete object that is often very large and time consuming to move. The metadata is used to identify and/or provide information regarding an object, such as the object type, version, and parameters that the data in the object represents.

An Object Identifier (“Oid”) is the globally unique identifier that is used to set each object or domain object apart. When an object or domain object of a particular type is created, a new Oid is generated for it. The Oid may be any suitable type of identifier. An exemplary identifier is a lightweight identifier such as a universally unique identifier (UUID) as specified in RFC 4122.

A Version Identifier (“Vid”) is the globally unique identifier that is used to set each version of an object or domain object apart. When an object or domain object of a particular type is created, a new Vid is generated for it, representing the initial, default state of the domain object. As each new version of the domain object is created as a result of self-consistent changes to the state, a new Vid is generated. An exemplary identifier is a lightweight identifier such as a universally unique identifier (UUID) as specified in RFC 4122.

Exemplary metadata that is associated with an object 30 is shown in FIG. 2. Such metadata is described as associated with a domain object, but may also be associated with any object or other data structure. Each object 30 may be imprecisely identified by a tuple (Name, Version Number), where “Name” is the object name 32, which may not be unique to the particular domain object 30, and “Version Number” may also not be unique to the domain object 30. Each object 30 may also be precisely identified by a tuple (Oid, Vid), where Oid 34 is an object identifier and Vid 36 is a version identifier. Each of the identifiers (Oid 34 and Vid 36) is universally unique such that, regardless of which user is editing an object 30, unrelated objects 30 will not have the same Oid 34 and two different edits of the same object 30 will not have the same Vid 36. All objects 30 resulting from the same initial object 30 will have the same Oid 34. However, when one object 30 stems from another, the two objects 30 will have a different Vid 36. Thus, the tuple (Oid, Vid) is unique for each non-identical object 30. The metadata may also include a list of all Vid 36 associated with that object 30, shown in FIG. 2 as a Version identifier List or “VidList” 38. This allows any two object identifiers to be compared to determine the object kinship (e.g., unrelated, identical, ancestor, descendant, or cousin). The metadata may also include a Parent Version Identifier (“ParentVid”), which connects or relates the VidList 38 to each version and associated Vid 36. The ParentVid indicates the previous version of a particular version of an object, i.e., the version of the object that was edited or otherwise use to create the particular version.

As described herein, “metadata” may refer to all data structures associated with an object that are not the data set (referred to as “actual data”) that is stored as the object. For example, metadata may refer to the object name, identifier, version identifier and the version identifier list. In other example, metadata may be described separate from the object identifier, such that a representation of an object can include the object identifier, metadata and/or the actual data. The object identifier and/or the metadata can thus be accessed, transmitted and stored independent of the data set while maintaining a relation to the data set.

For each node of the distributed object system, a mechanism is provided to organize the metadata for all objects represented on that node. Examples of this mechanism are described herein.

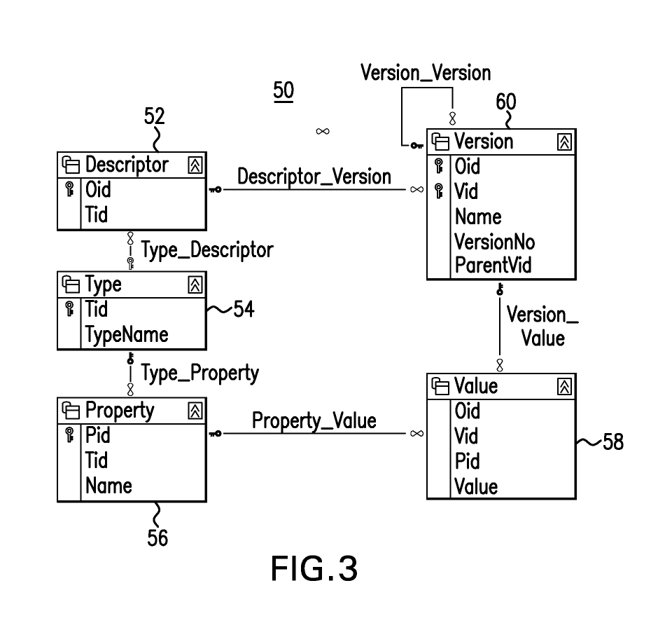

FIG. 3 shows an example of an organization scheme for metadata that may be applied to oil filed data and other energy industry data. A data model is shown that can efficiently respond to changes in organization of data. Newly designed objects can be stored and retrieved in a lossless manner without requiring redesign or reloading.

The data model employs an entity-attribute-value (“EAV”) approach, which is extensible in that new or modified domain object definitions can be easily added to an existing repository without redesign or reloading of the data. The EAV approach essentially allows a variable schema. This allows the data model to lead rather than follow. There is thus no need for a common data model as the data model used is fit for purpose.

FIG. 3 shows the relational schema that implements the EAV data model. Each block in the diagram 50 shown in FIG. 3 represents a relational table, which may be stored in a database or repository and accessible by a node. Each entry in the block represents a column in the table.

A descriptor table 52 (the “entity” of the EAV model) includes an Oid column for storing the unique identifier for an object and a Type identifier (“Tid”) column for storing an indication of the object type. A type table 54 includes the Tid and a Type Name column. A Property or parameter table 56 (the “attribute” of the EAV model) includes a Property identifier (“Pid”) column, a Tid column and a Property Name column. A Value table 58 includes an Oid column, a Value identifier (“Vid”) column for storing the Vid, a Pid column and a Value column for storing the actual property value. A Version table 60 includes Oid, Vid, Name, Version number, and ParentVid columns.

The lines between blocks represent one-to-many relations between the rows of one table and the rows of another table. The relations are from parent to child table. A key symbol designates the parent or “one” side of the relation and an infinity symbol designates the child or “many” side of the relation. In other words, a row in the parent table specifies zero or more rows in the child table. As shown, the Descriptor table 52 is a parent of the Version table 60, which is a parent of the Value table 58. The Property table 56 is also a parent of the Value table 58. The Type table 54 is a parent of the Descriptor table 52 and the Property table 56. The Version table 60 is a parent of itself and has a Version_Version relation which couples the ParentVid to the Vid.

The following table describes each element in the schema of FIG. 3:

| Element | Description |
|---|---|
| Descriptor Table | Includes one row for each domain object in the repository. |
| Version Table | Includes one row for each version of a domain object in the |
| | repository |
| Type Table | Includes one row for each type of domain object in the repository. |
| Property Table | Includes one row for each property of a domain object type |
| Value Table | Includes the value associated with the property for a specific |
| | version of a domain object. |
| Oid Column | The object identifier. Uniquely indicates a domain object. |
| Vid Column | The version identifier. The tuple (Oid, Vid) uniquely identifies a |
| | specific version of a domain object. Fully described in [1]. |
| Tid Column | The type identifier. Uniquely indicates a type of domain object. |
| | This is a UUID. |
| Pid | The property identifier. Uniquely indicates a property of a type of |
| | domain object. This is a UUID. |
| Name Column | The name of the domain object. |
| VersionNo Column | The version number of the domain object. The tuple (Name, |
| | VersionNo) is non-unique while tuple (Oid, Vid) is unique. This |
| | concept is described in [1]. |
| ParentVid Column | The Vid of the previous version, or empty (null) if the row |
| | represents the initial version of the domain object. |
| TypeName Column | The name of the type. |
| PropertyName Column | The name of the property. |
| Value Column | Includes the value for a property for a specific version of a |
| | domain object. |
| Descriptor_Version | Specifies the versions of a domain object. |
| Relation | |
| Type_Descriptor Relation | Specifies the domain objects that are of a type. |
| Type_Property Relation | Specifies the properties for a specific type. |
| Property_Value Relation | Specifies the values that are specified for a specific property. |
| Version_Value Relation | Specifies the values that are specified for a specific version of a |
| | domain object. |
| Version_Version Relation | Specifies the previous version of a version of a domain object. |

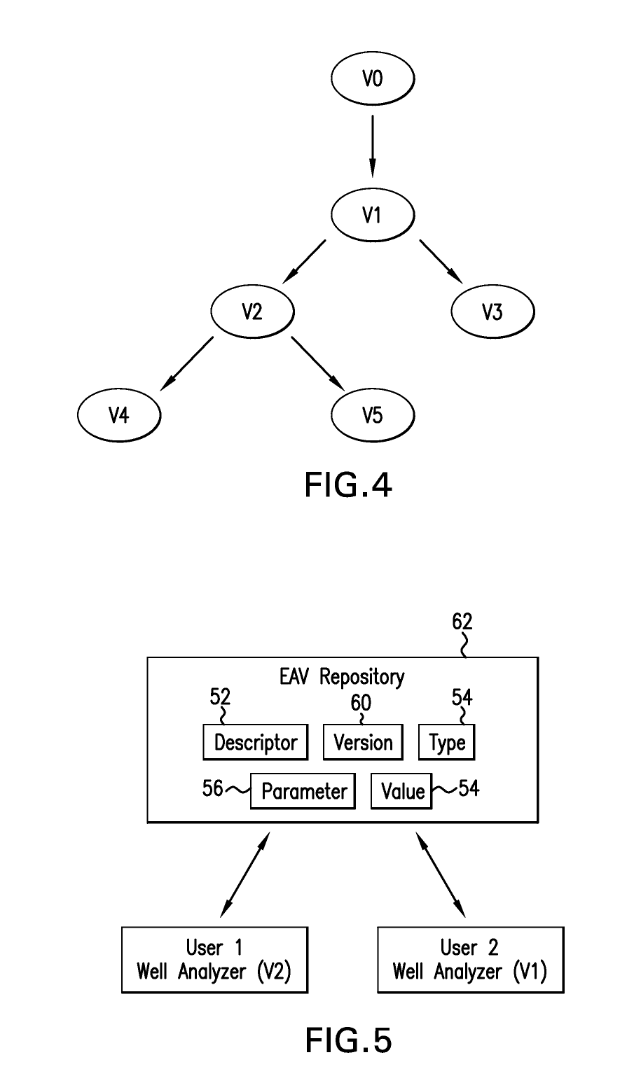

As discussed above, the ParentVid indicates the previous version of a particular version of an object. Because users can independently and potentially simultaneously access and edit data, the versions of an object may not necessarily follow a linear or chronological progression. For example, as shown in FIG. 4, if multiple users access and separately edit and save new versions of an object from the same previous version, the resulting set of versions forms a bifurcating tree of object versions.

The ParentVid, which associates each version with a parent version from which the version was created, allows this tree of object versions to be represented in a flat version table. For example, FIG. 4 illustrates that two users created separate versions (V2 and V3) from a previous version (V1), and two separate versions (V4 and V5) were created from the same previous version V2. Using the ParentVid, the relationships between versions can be represented in a version table as follows:

Version Table

| Oid | | Name | VersionNo | ParentVid |
|---|---|---|---|---|
| Column | Vid Column | Column | Column | Column |
| O1 | V0 | Object A | 1 | (Empty) |
| O1 | V1 | Object A | 2 | V0 |
| O1 | V2 | Object A | 3 | V1 |
| O1 | V3 | Object A | 3 | V1 |
| O1 | V4 | Object A | 4 | V2 |
| O1 | V5 | Object A | 4 | V2 |

The corresponding VidList (essentially a path from the root in this example) for each leaf of the tree can be represented as:

### V3=(V0, V1, V3)

### V4=(V0, V1, V2, V4)

### V5=(V0 V1, V2, V5)

FIG. 5 refers to an example of use of the EAV schema in accessing and editing objects from an EAV repository 62. The EAV repository 62 includes, in this example, various energy industry or oil and gas data collected from various operations and locations. Exemplary data includes well information, well log data, survey data and any other measurement data. Analysis data such as models may also be stored in the repository.

For illustrative purposes, the repository 62 is described as having two objects. A well object includes information regarding a specific well or borehole, such as location, depth, path description, well type (gas, oil, producer, exploration well, etc.) and state (e.g., open, active, closed, etc.). A log object includes logging data taken via, e.g., a wireline or logging-while-drilling (LWD) operation.

The Type table 54 thus includes two entries to indicate a well object and a log object, and two entries in the Descriptor table 52 (one the well and one for the log). There are corresponding entries in the Version table 60 for the well and the log.

For both the well type and the log type, several properties (attributes) are defined. In this example, there are three property entries in the Property table 56 (location, trajectory and state) and three property entries for the log (well, log kind and log header). The Property table thus has six rows. The Value table 58 also has six rows, three rows for each of the single versions of the two domain objects. The resulting repository appears as follows:

Descriptor Table

| Oid Column | Tid Column |
|---|---|
| O1 | T1 |
| O2 | T2 |

Version Table

| Oid | | Name | VersionNo | ParentVid |
|---|---|---|---|---|
| Column | Vid Column | Column | Column | Column |
| O1 | V1 | BHJ-10-1 | 1 | (Empty) |
| O2 | V2 | GR | 1 | (Empty) |

Type Table

| Tid Column | TypeName Column |
|---|---|
| T1 | Well Type |
| T2 | Log Type |

Parameter Table

| Pid Column | Tid Column | PropertyName Column |
|---|---|---|
| P1 | T1 | Well Location |
| P2 | T1 | Well Trajectory |
| P3 | T1 | Well State |
| P4 | T2 | Well |
| P5 | T2 | Log Kind |
| P6 | T2 | Log Header |

Value Table

| Oid | Vid | Pid | Value |
|---|---|---|---|
| O1 | V1 | P1 | (13942076, −35076495, −40.0) [Northing (ft), |
| | | | Easting (ft), Depth (ft)] |
| O1 | V1 | P2 | ((1247.42, 0.92175.4, 1345.3), (1.13, 201.92), . . . ) |
| | | | [MD (ft), Inc (deg), Azi (deg)] |
| O1 | V1 | P3 | (Type: Producer, Phase: Gas, Status: Open) |
| O2 | V2 | P4 | (O1,V1) |
| O2 | V2 | P5 | Gamma Ray |
| O2 | V2 | P6 | (25-Oct-2013 13:03:52, 1309.05-1343.66, 82-230, |
| | | | . . . ) [Sample date, depth range (ft), value range |
| | | | (gAPI), . . . ] |

Comparing this organization to a traditional approach shows that the schema used in the traditional approach would include more tables, columns and relations and fewer rows. As more domain object types are added, the EAV table schema will stay exactly the same—that is the number of tables, columns and relations will stay the same but only the number of rows in each table increases. In contrast, traditional approaches require the addition of tables, columns and relations. For example, the traditional schema will have a table for the well and the log and a new table for each new type of domain object.

The following example of a method of storing and processing data demonstrates the superiority of the above EAV repository over the traditional approach. This example also demonstrates how referential integrity is enforced.

In this example, nodes 64 and 66 are in communication with the repository 62. A user (“User 1”) accessing node 64, and a user (“User 2”) accessing node 66, connect to the repository using any suitable software or program, such as a software tool called Well Analyzer which performs a study on the wells and logs that are in the repository.

The repository has been populated with results from Well Analyzer version 1 (“V1”). If a user such as User 2 upgrades the software or an object in the repository, a new version is saved. Any new table fields required for the new version (e.g., object identifier, version identifier, property identifier and values, etc.) are automatically generated. If another user such as User 1 modifies the software or object, similar fields are created for this version, and separate sets of metadata and actual data are saved in the repository. Whenever a user accesses the software or object in the repository, the user will be notified of any versions that were created by other users.

For example, User 2 upgrades to version 2 (“V2”) of the Well Analyzer. Version V2 supports a new downhole equipment type called “Probe”. When User 2 saves his analysis to the repository using the new version of Well Analyzer, a new Probe domain object will be created. The EAV repository 62 easily supports this scenario. A new “Probe Type” is added to the Type Table 54 and the various attributes associated with the Probe Type are added to the Property table 56. The Value table 58 is then be populated with all the values for each well analysis that User 2 performs with the new tool.

Meanwhile, User 1, who is still using version V1 of the Well Analyzer, is unaware of the new results that have been saved in the repository 62. User 1 continues to work with the repository as if nothing had changed, and can save V1 results to the repository without affecting the V2 results that User 2 is creating. At the moment that User 1 upgrades to version V2 of the tool, User 1 automatically and immediately has access to the new results that User 2 has created and saved to the repository.

This is in stark contrast to the traditional approach where new versions of a tool will be unable to save new types of results to the repository without a significant change to the schema. This change in turn impacts all users of the repository and generally requires all users to upgrade to the same version of the tools when the repository is upgraded, which is a significant disruption and explains why traditional repository schemas are very slow to change and to adapt to changes in the capabilities of the tools that connect to them.

The embodiments described herein provide numerous advantages. Embodiments described herein allow for tracking and management of both the movement and change of objects so as to maximize the storage efficiency and network transfer, which cannot be effectively realized in prior art systems.

Embodiments described herein provide a metadata organization model that is superior to existing implementations, particularly for oil and gas or energy industry data, because of its capability to adapt to changing technology. For example, with an EAV Oil Field Repository, the data model can lead instead of follow, which permits the repository to keep pace with rapidly changing technology in the oil and gas industry.

Traditional oil field repositories require years of technical negotiation on the common data model. Once this common data model is in place, it is immediately obsolete as the technology for extracting oil and gas has made advances in the meantime.

The net effect of this “data model lag” is to prevent effective collaboration of oil field knowledge workers because the repository they are using always represents yesterday's technology and to innovate they are reduced to saving results in local storage, creating isolated pockets of data. The repository, rather than representing the most current thinking of the team of knowledge workers, becomes like a library reference stack, a set of valuable information that is becoming quickly obsolete. The EAV repository completely changes this dynamic: The repository is no longer backward looking but forward looking as well.

Many prior art systems utilize a common data model, which is a comprehensive set of domain object definitions that are in turn mapped to real world entities. The purpose of the common data model is to describe, for example, subsurface elements in a form that is suitable for processing by sophisticated tools with the objective of determining the location and volume of hydrocarbon assets and how best to extract them.

Because of the significant challenges associated with finding and extracting oil and gas the sophisticated tools set is constantly evolving. The problem with the common data model approach is that years are required to settle on a stable domain object definitions which are then immediately obsolete.

The EAV approach offers a number of advantages over traditional approaches. For example, the EAV approach provides an extensible data model. That is, new or modified domain object definitions can be easily added to an existing repository without redesign or reloading of the data. The EAV approach essentially allows for a variable schema. This allows the data model to lead rather than follow. There is simply no need for a common data model as the data model used is fit for the desired purpose.

In support of the teachings herein, various analyses and/or analytical components may be used, including digital and/or analog systems. The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

One skilled in the art will recognize that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A non-transitory computer-readable storage medium storing instructions which, when processed by a processor, cause the processor to implement a method of storing and transmitting energy industry data, the method comprising:
storing a data set as an object, the data set including energy industry data; and
generating metadata associated with the object, the metadata including at least an entity table storing a globally unique object identifier, a version table related to the entity table and storing a version identifier, a property table storing a property identifier that identifies a property described by the data set, and a value table related to the property table and storing a value of the property.

2. The storage medium of claim 1, wherein the object identifier and the metadata are configured to be transmitted and stored independent of the data set while maintaining a relation to the data set.

3. The storage medium of claim 1, wherein the data set and the metadata is stored at one or more locations in a distributed object network.

4. The storage medium of claim 3, wherein the network includes a centralized data repository connected to a plurality of nodes, the repository storing the object and the metadata and being accessible by a plurality of users.

5. The storage medium of claim 1, wherein generating the metadata includes generating the object identifier upon initial creation of the object and an initial version identifier, and generating a new version identifier for each new version of the object that is created.

6. The storage medium of claim 1, wherein a combination of the object identifier and the version identifier precisely identifies a specific version of the object.

7. The storage medium of claim 1, wherein the entity table has a parent relationship to the version table, and the version table and the property tables have a parent relationship to the value table.

8. The storage medium of claim 7, wherein the metadata further includes a type table having a parent relationship to the entity table and the property table, the type table identifying a type of data represented by the object.

9. The storage medium of claim 1, wherein the metadata is extensible and configured to store a new type of object without changing the organization of metadata stored for previously existing objects.

10. The storage medium of claim 1, wherein the property identifier identifies a property of at least one of a borehole and an earth formation.

11. A method of storing and transmitting energy industry data, the method comprising:
storing a data set as an object, the data set including energy industry data; and
generating metadata associated with the object, the metadata including at least an entity table storing a globally unique object identifier, a version table related to the entity table and storing a version identifier, a property table storing a property identifier that identifies a property described by the data set, and a value table related to the property table and storing a value of the property.

12. The method of claim 11, wherein the object identifier and the metadata are configured to be transmitted and stored independent of the data set while maintaining a relation to the data set.

13. The method of claim 11, wherein the data set and the metadata are stored at one or more locations in a distributed object network.

14. The method of claim 13, wherein the network includes a centralized data repository connected to a plurality of nodes, the repository storing the object and the metadata and being accessible by a plurality of users.

15. The method of claim 11, wherein generating the metadata includes generating the object identifier upon initial creation of the object and an initial version identifier, and generating a new version identifier for each new version of the object that is created.

16. The method of claim 11, wherein a combination of the object identifier and the version identifier precisely identifies a specific version of the object.

17. The method of claim 11, wherein the entity table has a parent relationship to the version table, and the version table and the property tables have a parent relationship to the value table.

18. The method of claim 17, further comprising generating a type table having a parent relationship to the entity table and the property table, the type table identifying a type of data represented by the object.

19. The method of claim 8, wherein the type table indicates whether the data set is a well type that includes values of properties of a borehole in an earth formation, or a log type that includes values of properties measured in or near the borehole.

20. The method of claim 11, wherein the property identifier identifies a property of at least one of a borehole and an earth formation.
